(19) United States
(12) Patent Application Publication
(10) Pub. No.: US 2009/0314995 A1
(43) Pub. Date: Dec. 24, 2009

(54) FUNCTIONALISED DOPANTS AND CONDUCTING POLYANILINE MATERIALS, BLENDS AND PROCESS THEREFOR

(75) Inventors: Manickam Jayakannan, Kerala (IN); Chennakkatu Krishna Sadasivan Pillai, Kerala (IN); Sundeep Kumar Dhawan, New Delhi (IN); Dinesh Chandra Trivedi, Tamil Nadu (IN); Radhakrishnan Subramaniam, Maharashtra (IN)

Correspondence Address: LADAS & PARRY LLP, 26 WEST 61ST STREET, NEW YORK, NY, 10023, US

(73) Assignee: COUNCIL OF SCIENTIFIC AND INDUSTRIAL RESEARCH

(21) Appl. No.: 12/164,643

(22) Filed: Jun. 30, 2008

Related U.S. Application Data
(63) Continuation-in-part of application No. PCT/IN2005/000461, filed on Dec. 30, 2005.

(51) Int. Cl. H01B 1/12; C09B 29/34

(52) U.S. Cl. 252/500; 534/651

(57) ABSTRACT

Conducting polymers based on renewable resource materials are very attractive because of their wide availability and lower cost compared to petroleum based products. Here we developed a novel dopant for electrically conducting polyaniline from renewable resource cardanol, the main component of cashew nut shell liquid (CNSL). The novel dopant 2-ω-unsaturated-4-hydroxy-4′-sulfinic acid azo benzene or otherwise known as cardanol azo sulfonic acid (1) is synthesized by reaction of diazotized sulphanilic acid (4-aminophenylsulfonicacid) with cardanol under the basic condition. The new cardanol azo sulfonic acid (1) has a long alkyl chains at the 2 positions, which increases the solubility of the dopant as well as polyaniline doped materials in common solvents for many applications. The present invention essentially comprises of three steps; (a) synthesis of cardanol azo sulfonic acid dopant 1 from cardanol (b) synthesis of electrically conducting polyaniline using 1 as dopant both doping the polyaniline emeraldine base in solution and melt and in-situ polymerization of aniline in presence of 1 in various organic and aqueous combination in the interfacial, emulsion and dispersion routes (c) preparation of polyaniline/dopant 1/thermoplastics blends in solution and melt process and controlling the particle size while maintaining the good morphology. The dopant (1) consisting polyaniline emeraldine salt and its thermoplastic blends are potential materials for various applications in opto-electronic industry.

### FIELD OF INVENTION

The present invention relates to functionalised dopants/conducting polyaniline materials from renewable resources, their blends and a process thereof. The invention further relates to methods of the preparation of polyaniline conducting materials, conductive blends and composites from said functionalized dopants, such as conductive films and bars.

### BACKGROUND OF INVENTION

Polyaniline is a significantly important conducting polymers due to its unique electrical; electrochemical, optical properties coupled with good environmental/chemical stability and low manufacturing cost [Handbook of Conducting Polymers, Eds. Skotheim, Terje A.; Elsenbaumer, Ronald L.; Reynolds, John R.; Marcel Dekker Inc., (1998)]. The properties of polyaniline can be reversibly controlled by simple protonation/deprotanation of acids/bases, which makes it potentially attractive in opto-electronic and biological applications [Shimano, James Y et al. Synth. Met. 2001, 123, 251-62]. However, the main disadvantage of the polyaniline is its poor processability due to the stiffness of its backbone [Kosonen, Harri et al. Macromolecules, 2000, 33, 8671-75 and Stockton, W. B. et al. Macromolecules, 1997, 30, 2717-25]. To improve the processability lot of research has been done by introducing substitution of alkyl chain on the aromatic ring or nitrogen atom [Moon, H. S. et al. Macromolecules 31 (1998) 6461. and Hua, M. Y. et al. Polymer 41 (2000) 813.] copolymerization of aniline with monomers containing solubilizing long alkyl or alkoxy side chains [Chan, H. S. O. et al. J. Am. Chem. Soc. 1995, 117, 8517] blends or composites with commercial thermoplastics/thermosets [Reference from Anand, J. et al. Prog. Polym. Sci. 1998, 23, 993]. Functionalized aromatic/aliphatic sulfonicacids such as camphor sulfonic acid, dodecylbenzenesulfonic acid and dodecylsulfonicacid are also employed as dopants for polyaniline and the resultant doped materials are found to be soluble and processable [MacDiarmid, A. G. Conducting Polymers and Related Materials, Salaneek W R, Lundstom J, Ramby R. (Eds), Oxford Science Publications, London, 1993.]. Despite the considerable efforts that have been made to discover new useful dopants for conducting polyaniline, there continues to be a need for novel dopants with increased solubility and increased processability. There is also a continuing need for novel electrically conducting polymers that can be prepared from inexpensive materials available from natural resources.

Several efforts have been made in the art to prepare renewable resource based dopant materials for polyaniline because of their wide availability and commercial interest. For example lignosulfonic acid [U.S. Pat. Nos. 5,968,417, 6,299,800, 6,764,617 and 6,059,999] has been successfully used as a dopant molecule for polyaniline. It provides a conducting ferromagnetic material comprising ferromagnetic iron oxide particles and a conducting polymer comprising lignosulfonic acid-doped polyaniline. Additionally U.S. Pat. No. 6,552,107 describes the development of functionalised sulfonic acid dopants of 3-pentadecyl phenol and its derivatives. 3-Pentadecylphenol was obtained from cardanol through an expensive high-pressure catalytic hydrogenation reaction. Further, the 3-pentadecyl phenol was converted into its aromatic sulfonic acids and employed as a dopant for polyaniline. However, the development of functionalized dopants directly from cardanol is more attractive because of the large availability of starting material as natural resource and also more economic via cost reduction by avoiding the expensive process such as hydrogenation. To our knowledge, there is no report on the utilization of cardanol-based molecules as dopants for polyaniline and other conducting polymers. The aromatic ring sulfonation of cardanol using sulphuric acid or chlorosulfuric acids are not feasible due to the formation of thick viscous resin instead of the sulfonation in the aromatic ring. The resin formation is anticipated due to the olefinic polymerization of the unsaturated double bonds present in the alkyl chains prior to the aromatic sulfonation.

### OBJECTS OF TIE INVENTION

The main object of the invention is to provide functionalised dopants/conducting polyaniline materials from renewable resources, their blends and a process thereof.

Another object of the invention is to provide a process for the preparation of functionalized cardanol azo sulfonic acid dopants for polyaniline directly from cardanol, which is the main component of the cashew nut shell liquid.

Another object of the invention is to provide a process for synthesis of highly conducting polyaniline by doping dopant 1 in intrinsically conducting polyaniline emeraldine base.

Yet another object of the present invention is to provide a process for the in-situ synthesis polymerization of aniline and cardanolazosulfonic acid to prepare highly conducting polyaniline.

Yet another object of the present invention is to provide a process for the synthesis of highly conductive polyaniline by optimizing the ratio of the dopant molecule 1 and the polyaniline emeraldine base ratio during the doping process.

Another objective of the present invention is to prepare a polyaniline/thermoplastic blends based on cardanol azosulfonic acid doped polyaniline materials.

Yet another objective of the present invention is to prepare a highly macroscopically ordered polyaniline/cardanol azo sulfonic acid and polyaniline/cardanol azo sulfonic acid/thermoplastic blends for selective applications in electronic industry.

Yet another objective of the present invention is to prepare a highly uniform particle size and excellent morphology polyaniline/cardanol azo sulfonic acid and polyaniline/cardanol azo sulfonic acid/thermoplastic blends for selective applications in electronic industry.

### SUMMARY OF THE INVENTION

In the light of the foregoing the applicant proposes a novel dopant, 2-ω-unsaturated-4-hydroxy4′-sulfinic acid azo benzene or otherwise known as cardanol azo sulfonic acid of formula (1) as represented below. It is prepared directly from inexpensive naturally occurring material cardanol, the main component of cashew nut shell liquid.

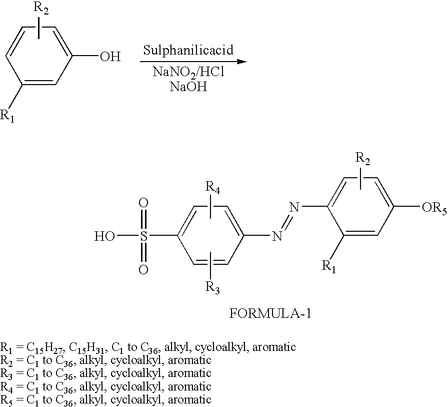

The new dopant is soluble in many solvents like water, methanol, tetrahydrofuran and dimethylsulfoxide, etc, and therefore, the polyaniline conducting materials can be prepared by both doping the polyaniline emeraldine base using the dopants in formula 1 in various solvents and in-situ polymerization of aniline in presence of formula 1. The molecule 1 is a crystalline solid, which facilitate the preparation of polyaniline doped conducting materials via many standard melt processing techniques. One of the significant features of the structure of the dopants prepared by the process of the present invention is that it has a flexible n-alkyl (C₁₅H₂₇) substituent, which makes the doped polyaniline melt processible and makes it possible for the preparation of highly transparent and conductive films and coatings.

The novel dopant cardanol azo sulfonic acid (1) has not been reported before for any application more particularly as a dopant molecule for conducting polyaniline. The present invention emphasizes on the direct utilization of cardanol for making a new cardanol azo sulfonic acid derivative through diazotization reactions. Diazotized sulphanilic acid (4-aminophenylsulfonicacid) was coupled with cardanol under basic condition to yield dopant. Under these basic reaction conditions, the side chain double bond in the cardanol is inactive and does not lead to the formation of resinous mass. The present process is very efficient in producing high purity sample and easily adaptable to large-scale synthesis. The new cardanol azo sulfonic acid (1) has a long alkyl chain at the 2 position, which increases the solubility of the dopant as well as polyaniline doped materials in common solvents for many applications in paints and film industry. Additionally the long alkyl chain acts as a plasticizer for the doped polyaniline materials, enhancing processability of the materials by hot pressing, compression molding and extrusion methods. The dopant has free reaction sites such as phenolic-OH and unsaturated double bonds in the long chains for further chemical transformations or grafting to other polymeric matrices to obtain compatible polyaniline composites.

Accordingly, the present invention provides a process of forming electrically conducting materials, conductive blends and composites using functionalized dopant prepared from renewable resources represented by the formula, which comprising the steps of (a) preparation of novel functionalised dopants having formula (1) directly from renewable resources based on cardanol (b) doping of the said dopant with substituted and unsubstituted conducting polymers in solution and melt and (c) blending of thermoplastics and thermosets with the doped electrically conducting polymers in solution and melt to obtain crystalline, good morphology and uniform particle size from 1 micron to 5 nm and having conductivity in the range of 0.01 to 100 S/cm.

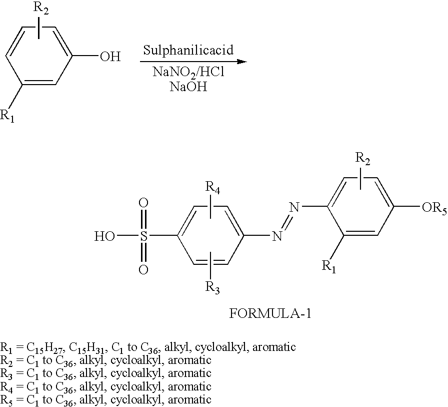

### BRIEF DESCRIPTION OF THE DRAWINGS

The other objectives, features and advantages of the invention will became apparent from the description and the accompanying drawing in which,

FIG. 1 represents the ¹H-NMR spectra of cardanol azo sulfonic acid (1) in dimethylesulfoxide-d₆. The different types of the protons in the structure are assigned by alphabets.

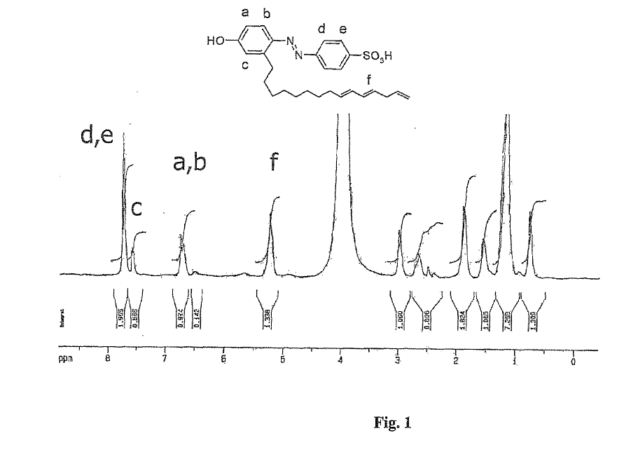

FIG. 2 represents the scanning electron microscopy pictures of melt processed cardanol azo sulfonic acid doped polyaniline thin film (a) and cardanol azo sulfonic acid doped polyaniline/polyethylene blend thin film (b).

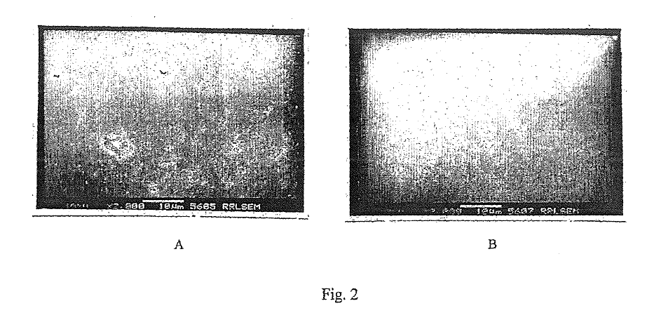

### DETAILED DESCRIPTION OF THE INVENTION

Embodiments of the invention will now be explained with reference to the accompanying drawings. It should be understood however that the disclosed embodiments are illustrative of the invention, and various modifications and variations are possible without departing from the scope and spirit of the invention. The following description and drawings are not to be construed as limiting the invention and the numerous specific details are described to provide a through understanding of the present invention, as the basis for the claims and as a basis for teaching one skilled in the art how to make and/or use the invention. However in certain instances, well-known or conventional details are not described so as not to obscure the present invention.

The present invention essentially comprises of synthesis of cardanol azo sulfonic acid dopant 1 from cardanol and using 1 as dopant for polyaniline emeraldine base in solution, melt and in-situ polymerization of aniline in presence of dopant 1 in various organic and aqueous combination in the interfacial, emulsion and dispersion routes. Further the cardanol azo sulfonic acid dopant 1 could also be used as one of the dopant along other sulfonic acids such as camphore sulfonic acid, p-toluene sulfonic acid, dodecyl sulfonic acid, all types of aromatic and aliphatic sulfonic acids. The dopant 1 doped polyaniline emeraldine salt can be processed alone or along with other thermoplastics in solution and melt process. By varying the polymerization conditions such as temperature, concentration, time and solvent polarity, the particle size and morphology of the resultant materials can be controlled. The doped materials can be processed in to various forms of objects such as thin films and bars.

In the present invention, conducting polyaniline/thermoplastic blends are prepared by solution casting and melt processing via hot pressing, extrusion, compressive molding and abrasive molding techniques. On doping the polyaniline with these dopants, plastification is also taking place simultaneously. Thus, these dopant acts as plasticising cum protonating agents. The conducting composites containing plastics such polyethylene, polyesters, polyamides, polyethers, polycarbonates, poly(vinylchloride), polystyrene, polypropylene, poly(methylmethacrylate), poly(vinylacetate), polyureas, polyurethanes, polysulfones, polyimides, and ethylene vinyl acetate, etc. The cardanol azo sulfonic acid doped polyaniline/polyethylene composites showed a conductivity of ca. 0.1 to 2 S/cm for the entire composition range of blends, which is usually required for antistatic materials.

In a preferred embodiment of the present invention the dopant cardanol azo sulfonic acid is synthesized from the renewable resource cardanol, the main component of cashew nut shell liquid, which is the industrial waste from cashew nut processing industry.

In another embodiment of the present invention the dopant cardanol azo sulfonic acid is synthesized via diazotization coupling of cardanol using commercially available cheap materials such as sulphanilic acid, sodium nitrite and sodium hydroxide, etc, in a less expensive processing at ambient temperature with the product formation of high purity and high yield.

In yet another embodiment of the present invention the polymerization of aniline was carried out in presence of cardanol azo sulfonic acid aqueous, organic, organic/aqueous mediums through interfacial, dispersion and emulsion polymerization routes at ambient conditions. The organic solvents include methanol, ethanol, tetrahydrofuran, dimethylsulfoxide, N,N-dimethylforamide, toluene, xylene, hydrocarbons and N-methylpyrrolidinone, etc and ammonium persulphate is used as the oxidant for all types of polymerization.

According to features of the present invention, the polyaniline-doped materials are processed into thin films and bars through solution casting and melt processing techniques. The melt processing includes hot pressing, extrusion, compressive molding and abrasive molding techniques. In the present invention, the polyaniline—cardanol azo sulfonic acid doped conducting materials are prepared by varying the amount of dopant from 0 to 100 mole or weight percent to fine-tune the conductivity ranging from 10⁻³ to 10² S/cm. Free standing flexible films can be prepared both by melt/solution processing by using solvents chloroform and m-cresol.

The important finding of the present invention is that adopting a new diazotization synthetic strategy cleverly prevented the resin formation side reaction during the sulfonation of cardanol. The current process of cardanol azo sulfonic acid dopant molecule preparation involves low cost diazotiation reaction using commercially cheap reagents in an eco-friendly approach. The present synthetic approach is also easily adaptable to large-scale manufacturing. The dopant represented by the formula 1 is a stable solid and easy to handle for making highly conductive polyaniline with conductivity greater more than 1 S/cm. The dopant molecule is stable at a temperature of up to 250° C. and has the potential for applications in high temperature opto-electronic device industry.

The new dopant molecule is freely soluble in many solvents such as water, methanol, ethanol, tetrahydrofuran, dimethylsulfoxide, N,N-dimethylforamide and N-methylpyrrolidinone, etc, and therefore, the doping of polyaniline emeraldine base can be carried out in a wide range of solvents depending up on the applications. The dopant has thermal stability up to 250° C. and therefore can also be processed along with polyaniline emeraldine base at higher temperatures.

The high solubility of formula 1 in many solvents such as water, methanol, ethanol, tetrahydrofuran, dimethylsulfoxide, N,N-dimethylforamide and N-methylpyrrolidinone, etc renders the polymerization of aniline in presence of dopant of formula 1 via many in-situ routes such as interfacial, emulsion, dispersion and mixture of organic/aqueous solvent combinations.

The composition of the dopant 1 and polyaniline emeraldine base was varied from 1 to 99 mole or weight percentage during the doping process. The thermoplastics includes polyethylene, polyesters, polyamides, polyethers, polycarbonates, poly(vinylchloride), polystyrene, polypropylene, poly(methylmethacrylate), poly(vinylacetate), polyureas, polyurethanes, polysulfones, polyimides, etc. The processing techniques of the polymer blends include the injecting molding, twin-screw compounding, compression molding, abrasive molding and hot pressing, etc. The composition of the blends varied from 1 to 99% of entire composition range.

The novel dopant cardanol azo sulfonic acid (1) is directly prepared from renewable resource material cardanol through diazotization reactions. The present process is very efficient and cost-effective for large-scale synthesis at ambient conditions in the laboratory. The long alkyl chain in the dopant (1) increases the solubility of the dopant in many common solvents like water, methanol, ethanol, tetrahydrofuran and dimethylsulfoxide which is very useful for polyaniline conducting coating technology in paints and film industry. The long alkyl chain also acts as a plasticizer and enhances the processability of the materials by hot pressing, compression molding and extrusion methods.

The renewable resource based new dopant is very attractive compared to the petroleum-based dopants because of large availability, low cost and ease of scale-up for industrial applications. The new dopant (1) doped polyaniline conducting materials show vast promise for industrial applications ranging from antistatic ESD coatings, absorption of radar frequencies, Corrosion prevention, EMI/RFI shielding, electrochemical actuators, lithographic resists, lightning protection, microelectronics, polymer electrolytes, photovoltaics, rechargeable batteries, solar cells, bio-sensors and light emitting diodes etc. So, the industries to which this invention can be applied are electronic industries, plastics industries, medical industries etc

The invention is described in detail in the following examples, which are given by way of illustration and therefore should not be construed to limit the scope of the present invention.

### EXAMPLE 1

Synthesis of Cardanol azo sulfonic acid (dopant 1): Sulphanilic acid (31.5 g, 0.18 mol) and sodium carbonate (7.95 g, 0.08 mol) were added into 300 ml of water and heated to 60-70° C. to dissolve the entire solid. It was further cooled to 5° C. and a cold solution of sodium nitrite (11.1 g, 0.16 mol) in water (32 ml) was added. The resultant yellow solution was poured into ice (200 g) containing conc. HCl (31.5 ml) and stirred using mechanical stirrer for 30 min at 5° C. It was added into a flask containing sodium hydroxide (18 g, 0.45 mol), distilled cardanol (45 ml, 0.15 mol), methanol (75 ml) and water (150 mL). The coupling reaction was continued with stirring for 3 h in the ice-cold condition using a mechanical stirrer. The reaction mixture was neutralized by addition of conc. HCl (150 ml) in crushed ice (300 g). The red precipitate was filtered using Buckner funnel and washed with water. The dried product weighed 64.18 g (88% yield). Melting point: 205-207° C. ¹H-NMR (in d₆-N,N-dimethylsulfoxide)δ: 7.75 ppm (b, 4H, Ar—H); 7.57 ppm (d, 1H, Ar—H); 7.75 ppm (s, 1H, Ar—H); 7.70 ppm (d, 1H, Ar—H); 5.24 ppm (b, 2H, CH═CH); 3.1-0.6 ppm (m, 23H, aliphatic-H). FT-IR (KBr): 3006.7, 2923.6, 2852.9, 1600.1, 1533.7, 1498.7, 1369.3, 13338.7, 1236.9, 1174.7, 1116.5, 1033.2, 1007.6, 820.1, 706.4 and 559.3 cm⁻¹. UV-Vis (in CH₃OH): λₘₐₓ=336 nm. Weight 64.18 g (88% yield).

### EXAMPLE 2

Doping of polyaniline emeraldine base with dopant 1 in organic solvents: Aniline (10 mL, 0.11 mol) was dissolved in HCl (1M, 200 mL) and taken in a 1000 mL three neck flask and cooled to 0° C. using ice. To this a pre-cooled solution of ammonium per sulphate (31.4 g, 0.138 mol) in HCl (1M, 100 mL) was added very carefully (exothermic reaction) in five portions in an interval of 5 minutes gap. Immediate appearance of pink colour was observed, which further turned into deep blue. After 5 minutes, green colored polyaniline-HCl emeralidine base precipitated from the solution. The polymerization was further proceeded by stirring at 30° C. for 24 h. The precipitate was filtered, washed with 1M HCl three times and added into a 1000 mL flask containing 1 M aqueous ammonia solution (450 mL, 25% solution in water). The blue precipitate was stirred for 3 h at room temperature to ensure the completion of dedoping. The resultant blue emeraldine base was filtered, washed successively with water, methanol and acetone to remove the un-reacted starting materials and oligomers. The blue colored material was dried in vacuum oven at 50° C. (1 mm of Hg) for 8 h. The dried polymer weighed 8.1 g (89% yield). 4.55 g of polyaniline emeraldine base and 12.1 g of dopant 1 were taken in 50 ml methanol and heated to reflux for 3 h. The green solid was filtered using Whatmann filter paper and the solid was washed with methanol until lo the filtrate became colorless. The green colored doped material was dried in vacuum oven at 50° C. (1 mm of Hg) for 8 h. The doped polymer weighed 12.34 g (74.11%). The compositions of cardanol azo sulfonic acid (formula 1) and polyaniline emeraldine base were varied in the feed from 1 to 99 mole or weight % to prepare polyaniline doped conducting materials containing various amounts of dopant 1.

### EXAMPLE 3

Emulsion polymerization of aniline in presence of dopant 1: Cardanol azo sulfonic acid (24.2 g, 0.05 mol) and aniline (4.8 ml, 0.05 mol) were taken in water (50 mL) and vigorously stirred for 10 min. Then toluene (50 mL) and water (50 mL) were added and stirred for 2 hr. The resultant solution was cooled to 0° C. using ice. Ammonium persulfate (14.28 g, 0.063 mol) was dissolved in water (25 mL) and cooled. It was then added into the reaction mixture with constant stirring. After 15 min green tinge appeared on the sides of the flask. The polymerization was continued by vigorous stirring at 30° C. for 24 h. The green precipitate was filtered and washed successively with water, methanol and acetone. The green colored doped material was dried in vacuum oven at 50° C. (1 mm of Hg) for 8 h. The compositions of cardanol azo sulfonic acid (formula 1) and aniline were varied in the feed from 1 to 99 mole or weight % to prepare polyaniline doped conducting materials. The emulsion polymerization was also carried out for various compositions in water/tetrahydrofuran, water/chloroform and other water/organic solvent mixtures.

### EXAMPLE 4

Interfacial polymerization of Aniline in presence of dopant 1: Cardanol azo sulfonic acid (24.2 g, 0.05 mol) and ammonium persulfate (14.28 g, 0.063 mol) were dissolved in water (75 mL). Aniline (4.8 mL, 0.05 mol) in toluene (75 mL) was transferred very carefully into the above solution. After 5 min a thin, vertical, green layer appeared which indicated the initiation of polymerization. The polymerization was allowed to proceed for 48 h without any disturbance. The precipitate was washed continuously with water, methanol, acetone and dried in vacuum oven at 50° C. (1 mm of Hg) for 8 h. The compositions of cardanol azo sulfonic acid (formula 1) and aniline were varied in the feed from 1 to 99 mole or weight % to prepare polyaniline doped conducting materials. Interfacial polymerization was also carried out for various compositions in water/tetrahydrofuran, water/chloroform and other water/organic solvent mixtures.

### EXAMPLE 5

Dispersion polymerization of aniline in presence of dopant 1: Cardanol azo sulfonic acid (24.2 g, 0.05 mol) and aniline (4.8 mL, 0.05 mol) were dissolved in water (75 mL) and stirred vigorously for 2 h. The resultant dispersion was cooled to 0° C. using ice. Ammoniumpersulfate (15.7 g, 0.069 mol) was dissolved in water (50 mL) and cooled. It was added drop wise in to the dispersion for 10 minutes with constant stirring. After 3 minutes, appearance of pale blue color was noticed and then green color particles precipitated from the solution. The polymerization was continued by vigorous stirring at 30° C. for 8 h. The green precipitate was filtered and washed successively with water, methanol, acetone and dried in vacuum oven at 50° C. (1 mm of Hg) for 8 h. The compositions of cardanol azo sulfonic acid (formula 1) and aniline were varied in the feed from 1 to 99 mole or weight % to prepare polyaniline doped conducting materials.

### EXAMPLE 6

Solution Processing of dopant-1 doped polyaniline conducting materials: Dopant-1 doped polyaniline conducting materials or equi-molar dopant 1 and polyaniline emeraldine base was placed into a high boiling point organic solvents such as toluene, xylene, 1,2-dichlorobezene, m-cresol, etc and refluxed/treated in an ultrasonic bath for 48 hours, and subsequently centrifuged. Minor insoluble solids were removed by decanting. By the solution casting method of the above prepared solution free standing flexible films could be prepared. The compositions of cardanol azo sulfonic acid (1) and polyaniline emeraldine base were varied in the feed from 1 to 99 mole or weight % to prepare polyaniline doped conducting materials.

### EXAMPLE 7

Melt Processing of dopant-1 doped polyaniline conducting materials: Dopant-1 doped polyaniline conducting materials or equimolar dopant 1 and polyaniline emeraldine base were mixed using a melt processing equipment at temperatures varying from 100 to 250° C. The melt mixed product was processed into film or bars using standard processing techniques such as injection molding, compression molding and abrasive molding, etc. The compositions of cardanol azo sulfonic acid (formula 1) and polyaniline emeraldine base were varied in the feed from 1 to 99 mole or weight % to prepare polyaniline doped conducting materials.

### EXAMPLE 8

Solution Processing of dopant-1 doped polyaniline/thermoplastic blends: Dopant-1 doped polyaniline conducting materials or equimolar dopant 1 and polyaniline emeraldine base and thermoplastics such as polyethylene and placed into a high boiling point organic solvents such as toluene, xylene, 1,2-dichlorobezene, m-cresol, etc and refluxed/treated in an ultrasonic bath for 48 hours, and subsequently centrifuged. Minor insoluble solids were removed by decanting. By the solution casting method of the above prepared solution free standing flexible films could be prepared. The compositions of cardanol azo sulfonic acid (formula 1)/polyaniline emeraldine base/polyethylene were varied in the feed from 1 to 99 mole or weight % to prepare polyaniline doped conducting blends. The compositions of cardanol azo sulfonic acid (formula 1) doped polyaniline emeraldine salt/polyethylene were also varied in the feed from 1 to 99 mole or weight % to prepare polyaniline doped conducting blends.

### EXAMPLE 9

Melt Processing of dopant-1 doped polyaniline conducting materials: Dopant-1 doped polyaniline conducting materials or equimolar dopant 1 and polyaniline emeraldine base and thermoplastics such as polyethylene and mixed using a melt processing equipment at temperatures varying from 100 to 250° C. The melt mixed product was processed into film or bars using standard processing techniques such as injection molding, compression molding and abrasive molding, etc. The compositions of cardanol azo sulfonic acid (formula 1)/polyaniline emeraldine base/polyethylene were varied in the feed from 1 to 99 mole or weight % to prepare polyaniline doped conducting materials. The compositions of cardanol azosulfonic acid (formula 1) doped polyaniline emeraldine salt/polyethylene were also varied in the feed from 1 to 99 mole or weight % to prepare polyaniline doped conducting blends.

Although the invention has been described with reference to the specific embodiments, this description is not intended to be construed in a limiting sense. Various modifications of the disclosed embodiments, as well as alternate embodiments of the invention will become apparent to persons skilled in the art upon reference to the description of the invention. It is therefore contemplated that such modifications can be made without departing from the spirit and scope of the present invention as defined in the appended claims.

1. An azo sulfonic acid of the formula 1 given below 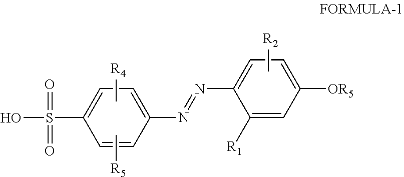
wherein
R₁ is C₁₅H₂₇, C₁₅H₃₁, C₁ to C₃₆ alkyl or alkenyls;
R₂ is H, C₁ to C₃₆ alkyl, cycloalkyl or aromatic;
R₃ is H, C₁ to C₃₆ alkyl, cycloalkyl or aromatic;
R₄ is H, C₁ to C₃₆ alkyl, cycloalkyl or aromatic;
R₅ is H, C₁ to C₃₆ alkyl, cycloalkyl or aromatic;

2. An azo sulfonic acid according to claim 1 wherein R₁ is a flexible linear alkyl group of 10 to 31 carbon atoms comprising one or two double bonds.

3. An azo sulfonic acid according to claim 2 wherein each of R₂, R₃, R₄ and R₅ is individually selected from the group consisting of alkyl of 1 to 10 carbon atoms.

4. An azo sulfonic acid according to claim 1 wherein R₁ has 15 carbon atoms.

5. An azo sulfonic acid according to claim 1 obtained by reaction of cardanol with sulfanilic acid.

6. A process of forming electrically conducting materials, conductive blends and composites, which comprises:
(a) doping substituted and unsubstituted conducting polymers in solution and melt form with the dopant of formula 1 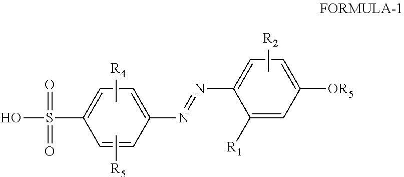
wherein
R₁ is C₁₅H₂₇, C₁₅H₃₁, C₁ to C₃₆ alkyl or alkenyls;
R₁ is C₁₅H₂₇, C₁₅H₃₁, C₁ to C₃₆ alkyl or alkenyls;
R₂ is H, C₁ to C₃₆ alkyl, cycloalkyl or aromatic;
R₃ is H, C₁ to C₃₆ alkyl, cycloalkyl or aromatic;
R₄ is H, C₁ to C₃₆ alkyl, cycloalkyl or aromatic;
R₅ is H, C₁ to C₃₆ alkyl, cycloalkyl or aromatic;
(b) blending of thermoplastics and thermosets with the doped electrically conducting polymers of step(a) in solution and melt to obtain crystalline and uniform particle size from 1 micron to 5 nm and having conductivity in the range of 0.01 to 100 S/cm.

7. A process according to claim 6 wherein said dopant is a compound of formula I wherein R₁ is a flexible linear alkyl group of 10 to 31 carbon atoms comprising one or two double bonds.

8. A process according to claim 7 wherein said dopant is a compound of formula wherein each of R₂, R₃, R₄ and R₅ is individually selected from the group consisting of alkyl of 1 to 10 carbon atoms.

9. A process according to claim 8 wherein said dopant is a compound of formula 1 wherein R₁ has 15 carbon atoms.

10. A process according to claim 9 wherein said dopant is obtained by reaction of cardanol with sulfanilic acid.

11. A process as claimed in claim 6 wherein the conducting polymer is polyaniline.

12. A process as claimed in claim 6 wherein the dopant is obtained from cashew nut shell liquid.

13. A process as claimed in claim 6 wherein the doping of polyaniline is carried by mechanically mixing the polyaniline emeraldine base with the dopant of formula (1) in the entire composition range by varying the amount of polyaniline emeraldine base/formula 1 in molar or weight ratio of 1 to 99%

14. A process as claimed in claim 6 wherein the doping of polyaniline is carried by mechanically mixing the polyaniline emeraldine base with the dopant of formula (1) as a primary dopant along with a secondary dopant selected from the group consisting of camphoresulfonic acid, aromatic sulfonic acids, aliphatic sulfonic acids and inorganic mineral acids, wherein the amount of primary and secondary dopant is varied in a molar or weight ratio of 1 to 99%.

15. A process as claimed in claim 6 wherein the amount of the doped polyaniline emeraldine salt in the thermoplastics or thermosets is in the range of 1 to 99% (molar or weight ratio).

16. A process as claimed in claim 6 wherein the doped polyaniline emeraldine salt and doped polyaniline/thermoplastic blend is thermally processed or solution cast into highly conducting free standing flexible films and bars of thickness varying from 1 micron to 1 cm size.

17. A process as claimed in claim 6 wherein the thermoplastic used is selected from the group consisting of polyethylene, polyesters, polyamides, polyethers, polycarbonates, poly(vinylchloride), polystyrene, polypropylene, polymethylmethacrylate), poly(vinylacetate), polyureas, polyurethanes, polysulfones and polyimides.

18. A process as claimed in claim 6 wherein polyaniline-dopant emeraldine salt used is prepared in organic solvent medium and organic-aqueous solvent mixtures by varying the amount of aniline and dopant of formula 1 in the molar ratio of 1 to 99%.

19. A process as claimed in claim 18 wherein the organic solvent used is selected from the group consisting of halogen containing solvents, acetone, tetrahydrofuran, aromatic and aliphatic hydrocarbon solvents with a carbon number between 2 to 36.

20. A process as claimed in claim 18 wherein, doped polyainiline emeraldine salt is prepared by interfacial polymerization, emulsion polymerization and dispersion polymerization in various aqueous-organic solvent combinations.

21. A process as claimed in claim 6 wherein, the dopant has thermal stability up to 250° C.

22. A process as claimed in claim 6 wherein, the polyaniline emeraldine salt and its thermoplastics blends are prepared in solution and melt in 1 micron to 5 nm particle size.
